(19) United States
(12) Patent Application Publication
(10) Pub. No.: US 2022/0059088 A1
(43) Pub. Date: Feb. 24, 2022

(54) ELECTRONIC DEVICE AND CONTROL METHOD THEREFOR

(71) Applicant: Samsung Electronics Co., Ltd., Suwon-si, Gyeonggi-do (KR)

(72) Inventors: Jaehun LEE, Suwon-si (KR); Yunsu LEE, Suwon-si (KR); Taeho HWANG, Suwon-si (KR); Hyonsok LEE, Suwon-si (KR); Mirae JEONG, Suwon-si (KR)

(21) Appl. No.: 17/299,061

(22) PCT Filed: Jan. 7, 2020
(86) PCT No.: PCT/KR2020/000261

§ 371 Date: Jun. 2, 2021

(30) Foreign Application Priority Data
Mar. 7, 2019 (KR) 10-2019-0026159

(51) Int. Cl. G10L 15/19; G06F 16/36; G06F 16/33; G06F 16/23; G06N 20/00

(52) U.S. Cl. CPC G10L 15/19; G06F 16/367; G10L 2015/088; G06F 16/23; G06N 20/00; G06F 16/3344

(57) ABSTRACT

An electronic device is disclosed. The electronic device of the present disclosure comprises a microphone, a memory including at least one command, and a processor which is connected to the microphone and the memory and controls the electronic device, wherein the processor, by executing the at least one command extracts a keyword from a user voice received as an input when the user voice is input through the microphone, acquires context information at the time when the user voice is input, acquires an object related to the user voice and knowledge information relating to the object, on the basis of the extracted keyword and the context information, and updates a stored knowledge database on the basis of the knowledge information relating to the object. In particular, at least a part of a method for providing a response to a user query by an electronic device may use an artificial intelligence model learned in accordance with at least one of machine learning, a neural network, and a deep-learning algorithm.

### TECHNICAL FIELD

This disclosure relates to an electronic device and a control method therefor. More particularly, this disclosure relates to an electronic device providing a response to a user query using context information and a control method therefor.

### BACKGROUND ART

In recent years, artificial intelligence (AI) systems have been used in various fields. An AI system is a system in which a machine learns, judges, and becomes smart, unlike an existing rule-based smart system. As the use of AI systems improves, a recognition rate and understanding or anticipation of a user's taste may be performed more accurately. As such, existing rule-based smart systems are gradually being replaced by deep learning-based AI systems.

AI technology may include machine learning, for example deep learning, and elementary technologies that utilize machine learning.

Machine learning may refer, for example, to an algorithmic technology that is capable of classifying or learning characteristics of input data. Element technology may refer, for example, to a technology that simulates functions, such as recognition and judgment of a human brain, using machine learning algorithms, such as deep learning. Machine learning may include technical fields such as linguistic understanding, visual understanding, reasoning, prediction, knowledge representation, motion control, or the like.

Various fields implementing AI technology may include the following. Linguistic understanding may refer, for example, to a technology for recognizing, applying, and/or processing human language or characters and may include natural language processing, machine translation, dialogue system, question and answer, speech recognition or synthesis, and the like. Visual understanding is a technique for recognizing and processing objects as human vision, including object recognition, object tracking, image search, human recognition, scene understanding, spatial understanding, image enhancement, and the like. Inference prediction is a technique for judging and logically inferring and predicting information, including knowledge-based and probability-based inference, optimization prediction, preference-based planning, recommendation, or the like. Knowledge representation is a technology for automating human experience information into knowledge data, including knowledge building (data generation or classification), knowledge management (data utilization), or the like. Motion control is a technique for controlling the autonomous running of the vehicle and the motion of the robot, including motion control (navigation, collision, driving), operation control (behavior control), or the like.

Recently, various services using an AI agent (e.g., Bixby™, Assistant™, Alexa™, or the like) providing a response to a user query are provided. However, when the AI agent is used, there is a limit in that the AI agent may not understand a term a user personally uses or a term that is not generally used and thus, the AI agent may not provide a response even though the information is important. When performing a dialogue with an AI agent, in the related art, it is necessary to perform a dialogue using only some general and clear terms, and thus there is a limitation of performing awkward dialogue with the AI agent.

### DISCLOSURE

### Technical Problem

It is an object of the disclosure to provide an electronic device which is capable of providing a natural dialogue with an artificial intelligence (AI) agent by establishing knowledge database using context information and providing a response to a user query using knowledge database and a control method therefor.

### Technical Solution

Accordingly, an aspect of the disclosure is to provide an electronic device which includes a microphone, a memory configured to include at least one command, and a processor connected to the microphone and the memory, and configured to control the electronic device, and the processor, by executing the at least one command, may, based on a user voice being input through the microphone, extract a keyword from the input user voice, obtain context information at a point in time when the user voice is input, obtain an object related to the user voice and knowledge information relating to the object, based on the extracted keyword and the context information, and update a knowledge database stored in the memory based on the object and the knowledge information relating to the object.

The knowledge database may store a relationship among knowledge information in an ontology format.

The processor may identify whether an entity relating to the obtained object is present in the knowledge database, and based on the entity relating to the object being present, update the knowledge database by adding, to the entity, the knowledge information relating to the object.

The processor may, based on the entity relating to the object not being present, generate a new entity corresponding to the object and update the knowledge database.

The memory may further include an artificial intelligence (AI) model trained based on at least one of a user interaction input to the electronic device, a user's search history, sensing information sensed by the electronic device, or user information received from an external device, and the processor may obtain the object related to the user voice and the knowledge information relating to the object by inputting the extracted keyword to the AI model.

The processor may, based on a user query being input, obtain a response to the user query using the updated knowledge database, and output the obtained response.

The electronic device may further include a communication interface, and the processor may transmit the updated knowledge database to an external server through the communication interface and receive knowledge database of another user from the external server.

The processor may obtain at least one of time information, location information, weather information, or schedule information of a point in time when the user voice is input as the context information.

The electronic device may further include a global positioning system (GPS) sensor, and the processor may obtain location information sensed by the GPS sensor at the point in time when the user voice is input as the context information, and obtain an object related to a place where the user voice is input based on at least one of the extracted keyword, the obtained location information, or prestored schedule information.

The electronic device may further include a communication interface, and the processor may obtain, from an external server, weather information of a point in time when the user voice is input through the communication interface as the context information, and obtain preference information of a user relating to the object as the knowledge information based on the extracted keyword and the obtained weather information.

According to an embodiment, a method of controlling of an electronic device includes, based on a user voice being input, extracting a keyword from the input user voice, obtaining context information at a point in time when the user voice is input, obtaining an object related to the user voice and knowledge information relating to the object, based on the extracted keyword and the context information, and updating a prestored knowledge database based on the object and the knowledge information relating to the object.

The knowledge database may store a relationship among knowledge information in an ontology format.

The updating may include identifying whether an entity relating to the obtained object is present in the knowledge database, and based on the entity relating to the object being present, updating the knowledge database by adding, to the entity, the knowledge information relating to the object.

The updating may include, based on the entity relating to the object not being present, generating a new entity corresponding to the object and updating the knowledge database.

The method may further include training a prestored artificial intelligence (AI) model based on at least one of a user interaction input to the electronic device, a user's search history, sensing information sensed by the electronic device, or user information received from an external device, and the obtaining the object and knowledge information relating to the object may include obtaining the object related to the user voice and the knowledge information relating to the object by inputting the extracted keyword to the AI model.

The method may include, based on a user query being input, obtaining a response to the user query using the updated knowledge database, and outputting the obtained response.

The obtaining the context information may include obtaining at least one of time information, location information, weather information, or schedule information of a point in time when the user voice is input as the context information.

The obtaining the context information may further include obtaining location information sensed by the GPS sensor at the point in time when the user voice is input as the context information, and the obtaining the knowledge information relating to the object may include obtaining an object related to a place where the user voice is input based on at least one of the extracted keyword, the obtained location information, or prestored schedule information.

The obtaining the context information may include obtaining, from an external server, weather information of a point in time when the user voice is input through the communication interface as the context information, and obtaining preference information of a user relating to the object as the knowledge information based on the extracted keyword and the obtained weather information.

A computer readable medium including a program to execute a control method of an electronic device to control the electronic device perform operations includes based on a user voice being input, extracting a keyword from the input user voice, obtaining context information at a point in time when the user voice is input, obtaining an object related to the user voice and knowledge information relating to the object, based on the extracted keyword and the context information, and updating a prestored knowledge database based on the object and the knowledge information relating to the object.

### Effect of Invention

According to various embodiments, an electronic device may establish knowledge database using context information and provide a response to a user query using knowledge database.

### DESCRIPTION OF DRAWINGS

FIG. 1 is a usage map of an electronic device including an AI agent function providing a response to a user query according to an embodiment;

FIG. 2 is a block diagram briefly illustrating a configuration of an electronic device according to an embodiment;

FIG. 3 is a block diagram illustrating a configuration of the electronic device of FIG. 2 in detail;

FIG. 4 is a diagram illustrating an operation of updating knowledge database of an electronic device according to an embodiment;

FIG. 5 is a diagram illustrating an operation of receiving a user voice by an electronic device according to an embodiment;

FIG. 6 is a diagram illustrating an operation of obtaining an object and information relating to the object based on an input user voice by the electronic device according to an embodiment;

FIG. 7 is a diagram illustrating an operation of an electronic device using an AI model according to an embodiment;

FIG. 8 is a diagram illustrating an operation of the AI model of FIG. 7;

FIG. 9 is a diagram illustrating an operation of updating knowledge database according to an embodiment;

FIG. 10 is a diagram illustrating an operation of outputting a response to a user query by an electronic device according to an embodiment; and,

FIG. 11 is a flowchart illustrating an operation of updating knowledge database of the electronic device according to an embodiment.

### BEST MODE FOR CARRYING OUT THE INVENTION

Hereinafter, embodiments of the disclosure will be described with reference to the accompanying drawings. However, this disclosure is not intended to limit the embodiments described herein but includes various modifications, equivalents, and/or alternatives. In the context of the description of the drawings, like reference numerals may be used for similar components.

In this specification, the expressions “have,” “may have,” “include,” or “may include” or the like represent presence of a corresponding feature (for example: components such as numbers, functions, operations, or parts) and does not exclude the presence of additional feature.

In this document, expressions such as “at least one of A [and/or] B,” or “one or more of A [and/or] B,” include all possible combinations of the listed items. For example, “at least one of A and B,” or “at least one of A or B” includes any of (1) at least one A, (2) at least one B, or (3) at least one A and at least one B. As used herein, the terms “first,” “second,” or the like may denote various components, regardless of order and/or importance, and may be used to distinguish one component from another, and does not limit the components.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a central processing unit (CPU) or an application processor) that can perform the corresponding operations by executing one or more software programs stored in a memory device.

The electronic device according to various embodiments may include at least one of, for example, smartphones, tablet personal computers (PCs), mobile phones, video telephones, electronic book readers, desktop PCs, laptop PCs, netbook computers, workstations, servers, a personal digital assistance (PDA), a portable multimedia player (PMP), an MP3 player, a medical device, a camera, or a wearable device. A wearable device may include at least one of an accessory type (e.g., a watch, a ring, a bracelet, an ankle bracelet, a necklace, a pair of glasses, a contact lens or a head-mounted-device (HMD)); a fabric or a garment-embedded type (e.g.: electronic cloth); skin-attached type (e.g., a skin pad or a tattoo); or a bio-implantable circuit. In some embodiments, the electronic device may include at least one of, for example, a television, a digital video disk (DVD) player, an audio system, a refrigerator, air-conditioner, a cleaner, an oven, a microwave, a washing machine, an air purifier, a set top box, a home automation control panel, a security control panel, a media box (e.g., SAMSUNG HOMESYNC™, APPLE TV™, or GOOGLE TV™), a game console (e.g., XBOX™ PLAYSTATION™), an electronic dictionary, an electronic key, a camcorder, or an electronic frame.

In other embodiments, the electronic device may include at least one of a variety of medical devices (e.g., various portable medical measurement devices such as a blood glucose meter, a heart rate meter, a blood pressure meter, or a temperature measuring device), magnetic resonance angiography (MRA), magnetic resonance imaging (MRI), computed tomography (CT), or ultrasonic wave device, etc.), a navigation system, a global navigation satellite system (GNSS), an event data recorder (EDR), a flight data recorder (FDR), an automotive infotainment devices, a marine electronic equipment (e.g., marine navigation devices, gyro compasses, etc.), avionics, a security device, a car head unit, industrial or domestic robots, a drone, an automated teller machine (ATM), a point of sale of a store, or an Internet of Things (IoT) device (e.g., light bulbs, sensors, sprinkler devices, fire alarms, thermostats, street lights, toasters, exercise equipment, hot water tanks, heater, boiler, etc.).

In this disclosure, the term “user” may refer to a person who uses an electronic device or a device (e.g., an artificial intelligence (AI) electronic device) that uses an electronic device.

The embodiment will be further described with reference to the drawings.

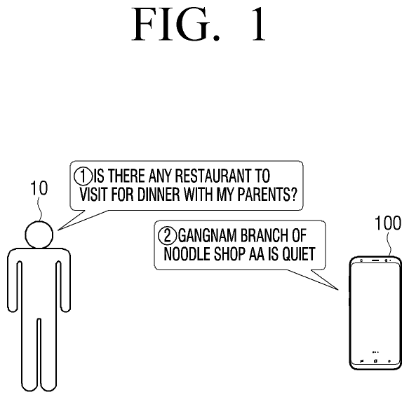

FIG. 1 is a usage map of an electronic device including an AI agent function providing a response to a user query according to an embodiment.

The AI agent system may, as illustrated in FIG. 1, include an electronic device 100 and a response providing server 200. The electronic device 100 may provide a user with a response to a user query using an AI agent program.

The electronic device 100 may store knowledge database in a memory. The knowledge database is a database for storing knowledge information for respective users using the electronic device 100. The knowledge database may be trained based on various user information such as user interaction, user's search history, sensing information sensed by the electronic device, user information received from an external device, or the like, which are input to the electronic device 100 by the user using the electronic device 100.

The knowledge database may store knowledge information trained by various information of the user in an ontology form. When the knowledge information is stored in an ontology form, the electronic device 100 may update and store a relationship between the obtained additional information and new knowledge information. Here, the relationship between the knowledge information may be formed based on various criteria. For example, other knowledge information may be connected based on location, preference, type, similarity, and mood for specific knowledge information.

The storage format of knowledge information in the form of ontology is merely an example, and knowledge information may be stored in a graph model, or the like. The knowledge database may store knowledge information trained based on various information of the user in a dataset form. Respective knowledge information elements constituting the knowledge database may be referred to as an entity, a parameter, a slot, or the like.

The electronic device 100 may receive a user query from a user 10. As shown in FIG. 1, the electronic device 100 may receive a user query through a user voice, but this is merely exemplary, and may receive a user query through various input methods such as a touch input, a keyboard input, or the like.

The electronic device 100 may receive a user voice including a trigger word for activating an AI agent program prior to receiving a user query. For example, the electronic device 100 may receive a user voice including a trigger word such as a “Bixby” prior to receiving a user query. When a user voice including a trigger word is input, the electronic device 100 may execute or activate an AI agent program and wait for an input of a user query. The AI agent program may include a dialog system capable of processing a user query and a response with a natural language.

The electronic device 100 may receive a user voice including a user query. For example, the electronic device 100 may receive a user query of “is there any restaurant to visit for dinner with my parents?”.

The electronic device 100 may extract “parents” and “dinner” from texts included in a user query as a keyword, and may provide a response considering a dinner menu, a place, a mood, or the like, based on the knowledge information stored in the knowledge database.

The electronic device 100 may expand a keyword using various context information as well as keywords extracted from a user voice, and may generate a response based on the expanded keyword. The electronic device 100 may expand or change the keyword in further consideration of at least one of user profile information (e.g., user preference information, search information, etc.), sensing information (e.g., location information, etc.) sensed by the electronic device 100, or information (e.g., weather information, etc.) received from the external server. For example, the electronic device 100 may change or expand the keywords “parents” and “dinner”, which are extracted from a user query based on context information at the time when the user query is received and profile information of the user to “Korean food,” “quiet,” “Gangnam,” and “weekend”.

The electronic device 100 may search an entity included in the knowledge database based on the extracted keyword and expanded keyword and may provide a user with the search result as a response.

For example, the electronic device 100 may provide a response “Gangnam branch of noodle shop AA is quiet” to a user. For example, the electronic device 100 may output a response in a voice or a message format.

In the embodiment above, the response to the user query is provided using the knowledge database stored in the electronic device 100, but this is merely an embodiment, and the electronic device 100 may receive a response to a user query from an external server.

In the embodiment, it is described that the knowledge database is stored in the electronic device 100, but this is merely exemplary, and the knowledge database may be stored in a separate external server. The knowledge database stored in the external server may be accessed by the electronic device 100 only when logged in by a separate user account.

The electronic device 100 may use the AI agent to provide a response to the above-mentioned user inquiry. At this time, the AI agent is a dedicated program to provide AI-based services (for example, speech recognition services, secretarial services, translation services, search services, etc.) and may be executed by existing general-purpose processors (for example, CPUs) or separate AI-only processors (for example, GPUs). The AI agent may control a variety of modules (for example, dialogue systems) that will be described in further detail in this disclosure.

When a predetermined user voice (e.g., “Bixby” or the like) is input or a button (e.g., a button for executing an AI agent) provided in the electronic device 100 is pressed, an AI agent may operate. The AI agent may provide a response to the user query based on the keyword included in the user query and the context information at the time when the user query is inputted based on the knowledge database.

If a predetermined user voice (e.g., “Bixby”, etc.) is input or a button (e.g., a button for executing the AI agent) provided in the electronic device 100 is pressed, the AI agent may operate. The AI agent may have been previously executed before a predetermined user voice (e.g., “Bixby” or the like) is input or a button (e.g., a button for executing the AI agent) provided in the electronic device 100 is pressed. In this example, the AI agent of the electronic device 100 may provide a response to the user query after the predetermined user voice (e.g., “Bixby”, etc.) is input or a button (e.g., a button for executing the AI agent) provided in the electronic device 100 is pressed. For example, when the AI agent is executed by an AI-dedicated processor, before a predetermined user voice (e.g., “Bixby”, etc.) is input or the button (e.g., a button for executing the AI agent) is pressed, the function of the electronic device 100 may be executed by the general purpose processor, and after a predetermined user voice (e.g., “Bixby”, etc.) is input or a button for executing the AI agent) provided in the electronic device 100 is pressed, the function of the electronic device 100 may be executed by the AI-dedicated processor.

The AI agent may be in a standby state before a predetermined user voice (e.g., “Bixby”, etc.) is input or a button (e.g., a button for executing the AI agent) provided in the electronic device 100 is pressed. The standby state may refer to a state in which a predefined user input is received to control the operation of the AI agent. When a predetermined user voice (e.g., “Bixby”, etc.) is input or a button (e.g., a button for executing the AI agent) provided in the electronic device 100 is pressed while the AI agent is in a standby state, the electronic device 100 may operate the AI agent and provide a response to the user query using the operated AI agent.

The AI agent may be a state of being terminated before a preset user voice (e.g., “Bixby” or the like) is input or a button (e.g., a button for executing the AI agent) provided in the electronic device 100 is pressed. When a predetermined user voice (e.g., “Bixby”, etc.) is input or a button (e.g., a button for executing the AI agent) provided in the electronic device 100 is pressed while the AI agent is terminated, the electronic device 100 may execute the AI agent and provide a response to the user query using the executed AI agent.

The AI agent may control various devices or modules to be described later. This will be described in greater detail later.

Detailed examples of changing or expanding a text included in the user query by using various models learned between the electronic device 100 and the server, and providing a response using the changed text will be described below through various embodiments.

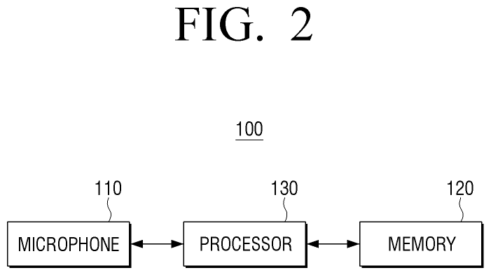

FIG. 2 is a block diagram briefly illustrating a configuration of an electronic device according to an embodiment.

Referring to FIG. 2, the electronic device 100 may include a microphone 110, a memory 120, and a processor 130. The embodiment is not limited thereto and some configurations may be added or omitted according to a type of the electronic device.

The microphone 110 is configured to receive a user voice uttered by a user. The microphone 110 may generate (or convert) a voice or a sound received from the outside to an electrical signal by the control of the processor 130. The electrical signal generated by the microphone 110 may be converted by the control of the processor 130 and stored in the memory 120.

The memory 120 may store a command or data related to at least one another element of the electronic device 100. The memory 120 may be implemented, for example, as a non-volatile memory, a volatile memory, a flash memory, a hard disk drive (HDD), a solid state drive (SSD), or the like. The memory 120 may be accessed by the processor 130 and reading/writing/modifying/deleting/updating of data by the processor 130 may be performed. It is understood that the term memory 120 may include any volatile or non-volatile memory, a ROM (not shown), RAM (not shown) proximate to or in the processor 130 or a memory card (for example, a micro SD card, a memory stick) mounted to the electronic device 100. The memory 120 may store programs, data, or the like, to configure various screens to be displayed on a display area of the display.

In addition, the memory 120 may store an AI agent for operating the dialogue system. Specifically, the electronic device 100 may use an AI agent to generate a natural language in response to user's utterance. At this time, the AI agent is a dedicated program for providing an AI-based service (e.g., a speech recognition service, a secretary service, a translation service, a search service, etc.). In particular, the AI agent may be executed by an existing general-purpose processor (e.g., a central processing unit (CPU)) or a separate AI-only processor (e.g., a graphics processing unit (GPU), etc.).

The memory 120 may include a plurality of configurations (or modules) constituting the dialogue system. The memory 120 may include knowledge database trained by a user using the electronic device 100. The knowledge database may store a relation among knowledge information in an ontology format.

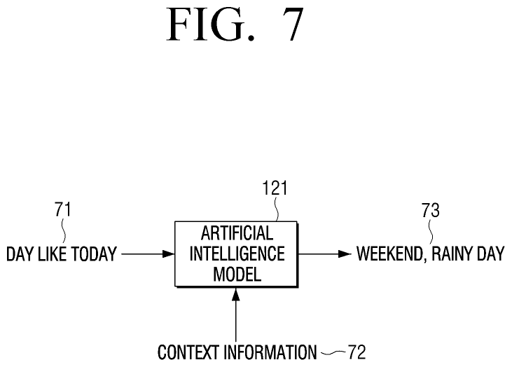

The memory 120 may further store the AI model trained based on at least one of a user interaction and a search history of the user input to the electronic device 100, sensing information sensed by the electronic device 100, or user information received from the external device. The AI model may learn the tendency, preference, or the like, of a user, and when a keyword extracted from a user voice inputted through the microphone 110 is inputted to the AI model, an object related to the user voice or knowledge information about the object may be output. The AI model may further input context information at a point in time of user voice input time as well as a keyword. An embodiment using the AI model will be described in greater detail with reference to FIG. 7.

The processor 130 may be electrically connected to the microphone 110 and the memory 120 to control the overall operation and function of the electronic device 100. When a user voice is input through the microphone 110 by executing at least one instruction stored in the memory 120, the processor 130 may extract the keyword from the inputted user voice.

The processor 130 may input the user voice inputted through the microphone 110 to an automatic speech recognition (ASR) module and may convert the user voice to a text. The processor 130 may, when receiving a user voice signal including a triggering word through the microphone 110, may input the input user voice signal to the ASR module.

The ASR module may convert the input user voice (especially, user query) to text data. For example, the ASR module may include an utterance recognition module. The speech recognition module may include an acoustic model and a language model. For example, the acoustic model may include information related to vocalization, and the language model may include information about unit phoneme information and the combination of unit phoneme information. The speech recognition module may convert the user speech into text data using information related to the vocalization and information on the unit phoneme information. Information about the acoustic model and language model may be stored in, for example, an automatic speech recognition database (ASR DB).

The processor 130 may extract a keyword from the text which is obtained by converting the user voice. The keyword may be a noun, pronoun, adjective, or the like, included in the text sentence.

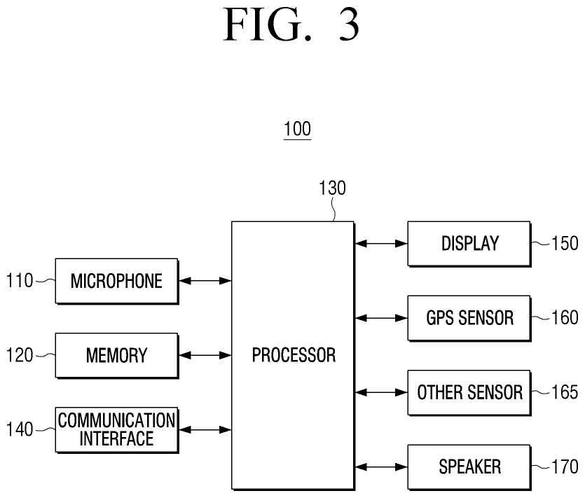

The processor 130 may obtain context information of the time when the user voice is received. The context information may include at least one of time information, location information, weather information, or schedule information at the time when the user voice is input. The time information may include information regarding a date, day, and time of the point in time when the user voice is input. An operation of obtaining the context information will be described in greater detail with reference to FIG. 3 below.

The processor 130 may obtain the object related to the user voice and knowledge information about the object based on the extracted keyword and context information. Here, the object may refer to a target of knowledge information included in the user voice. The obtained object and the knowledge information about the object may be the extracted keyword or that the extracted keyword is changed or expanded based on the context information.

The processor 130 may obtain the object related to the user voice and knowledge information about the object using an artificial intelligence model stored in the memory 110. The AI model may be trained based on at least one of a user interaction input to the electronic device 100, a search history of a user, sensing information sensed by the electronic device, or user information received from an external device.

The processor 130 may input the extracted keyword into a trained AI model to obtain knowledge information about the object and the object related to the user voice. According to another embodiment, the processor 130 may further input context information at the time when the user voice is input to the trained artificial intelligence model to obtain knowledge information for the object and the object related to the user voice.

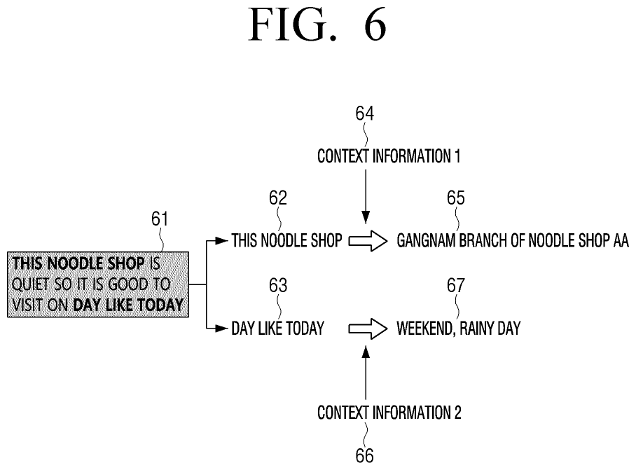

An embodiment of obtaining the object and knowledge information about the object based on at least one of the extracted keyword, context information, and the AI model will be described in greater detail with reference to FIGS. 6 and 7.

The processor 130 may update the knowledge database stored in the memory 110 based on the obtained object and the knowledge information about the object.

The processor 130 may identify whether an entity related to the obtained object is present in the knowledge database. The entity related to the object may include at least one of the entity corresponding to the object, the entity of an upper notion of the object, or the entity of a lower notion of the object.

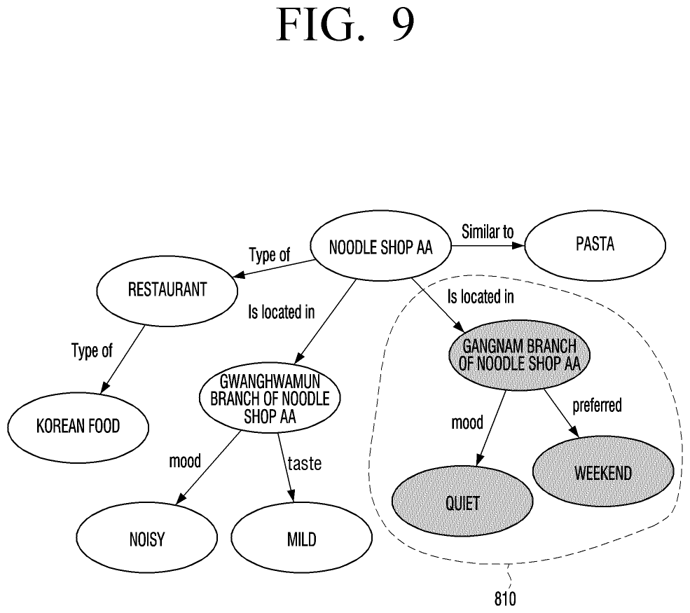

When an entity related to the object obtained in the knowledge database exists, the processor 130 may add knowledge information about the object to the entity to update the knowledge database. An embodiment of updating the knowledge database by adding obtained knowledge information to the entity will be described in more detail with reference to FIG. 9.

When the entity related to the obtained object is not present in the knowledge database, the processor 130 may update the knowledge database by generating a new entity corresponding to the obtained object.

The processor 130, when a user query is input, may obtain the response to the user query using the updated knowledge database.

When the user query is input, the processor 130 may obtain the response to the user query using the dialogue system stored in the memory 120. The dialogue system is configured to perform dialogue with a virtual AI agent using a natural language, and according to an embodiment, the dialogue system may be stored in the memory 120 of the electronic device 100. The embodiment is merely exemplary, at least one included in the dialogue system may be included in at least one server.

The dialogue system may further include an automatic speech recognition (ASR) module, a natural language understanding (NLU) module, a dialogue manager (DM) module, a natural language generator (NLG) module, and a text to speech (TTS) module. The dialogue system may further include a path planner module or an action planner module.

The processor 130, when a user voice is input, may input the user voice to the ASR module and convert the voice to text data. The ASR module has been described and will not be further described to avoid redundancy.

The processor 130 may input the converted text to the NLU module to recognize the intention of a user by performing syntactic analysis or semantic analysis. Grammatical analysis may divide the user input in grammatical units (for example: words, phrases, morphemes, or the like), and grasp which grammatical elements the divided units have. The semantic analysis may be performed using semantic matching, rule matching, formula matching, or the like. The NLU module may obtain domain, intent, or parameter (or slot) for expressing the intent by the user input.

The NLU module may determine user intention and parameters using the matching rule divided into a domain, an intention, and a parameter (or a slot) for grasping the intention. For example, the one domain (e.g., a restaurant) may include a plurality of intents (e.g., restaurant search, restaurant recommendation, or the like), and one intention may include a plurality of parameters (e.g., time, place, taste, mood, or the like). The plurality of rules may include, for example, one or more mandatory element parameters. The matching rule may be stored in a natural language understanding database (NLU DB).

The NLU module may grasp the meaning of a word extracted from a user input using a linguistic characteristic (e.g., a grammatical element) such as a morpheme or a phrase, and determine a user intention by matching the grasped meaning with the domain and the intention. For example, the NLU module may determine the user's intention by calculating how many words extracted from user input are included in each domain and intention. According to an example embodiment, the NLU module may determine the parameters of the user input using words that become a basis for understanding the intent. According to an example embodiment, the NLU module may determine the user's intention using the natural language recognition database in which the linguistic characteristic for grasping the intention of the user input is stored.

The NLU module may understand the user query using the AI model trained by users. The NLU may input the keyword of the user query and the context information of the point in time of user query to the AI model and output the object related to the user query and the user's preference condition information. The AI model may be trained based on at least one of the user interaction and user's search history input to the electronic device, the sensing information sensed by the electronic device 100, or the user information received from the external device.

The NLU may determine the user's intention using the trained AI model. For example, the NLU module may determine the user's intent using the user's information (e.g., preferred phrase, preferred menu, preferred time, user tendency, or the like). According to an embodiment, not only the NLU module but also ASR module may recognize the user voice in reference to the AI model.

The dialogue manager module may determine whether the intention grasped by the NLU module is clear. For example, the dialogue manager module may identify whether the user's intention is clear based on whether the information about the parameters are sufficient. The dialogue manager module may determine whether the intention grasped by the NLU module is clear. For example, the dialogue manager module may identify whether the user's intention is clear based on whether the information about the parameters are sufficient. The dialogue manager module may identify whether the parameters grasped by the NLU module is sufficient to perform tasks. According to an embodiment, when the intention included in the voice is not clear, the dialogue manager module may perform feedback for requesting necessary information to the user. The DM module may generate and output a message to identify a user query including a text changed by the NLU module.

According to an embodiment, the DM module may include a content provider module. The content provider module may generate a result of performing a task corresponding to the user input when an operation may be performed based on the intent and parameter grasped in an NLU module 1220.

According to an embodiment, the DM module may provide a response to the user query using knowledge database. The knowledge database may be included in the electronic device 100, but this is merely an embodiment, and may be included in the external server.

The natural language generation module (NLG module) may change the specified information into a text form. The specified information changed in a text form may be in the form of a natural language. The designated information may be, for example, response information about the question or information (e.g., feedback information about the user input) that guides further input of the user. The information converted in a text form may be displayed on the display (150 of FIG. 3) of the electronic device 100, or may be converted in a speech form by the text-to-speech module.

The text-to-speech module may change text-format information to speech-format information. The TTS module may receive the text type information from the natural language generation module and change the text format information to the voice format information, and may output the changed information using a speaker (170, FIG. 3).

The natural language understanding module and the dialogue manager module may be implemented as one module. For example, the NLU module and the dialogue manager module may be implemented as one module. For example, the natural language understanding module and the dialogue manager module may be implemented as one module to determine the intention of the user and the parameter, and obtain a reply (e.g., a path rule) corresponding to the determined user's intention and the parameter. As a still another example, the NLU module and the DM module may change or expand the keyword included in the user query based on the trained AI model and may obtain the object and the condition information about the object, and may obtain a response to the user query based on the obtained object, the condition information about the object, and the knowledge database.

It is described that, when a user voice is inputted through the microphone 110, the context information of the point in time when the user voice is input is further used to obtain the object related to the user voice and knowledge information relating to the object. However, in actual implementation, even if a user voice input is not performed, when the user performs text input through the application, the user may obtain knowledge information about an object and the object related to the input text by using the context information at the time when the text is inputted. The operation of the electronic device 100, which is performed when a user's voice is input, may be performed in the same manner even when a user inputs text. Alternatively, when the user voice input and the text input are performed within a predetermined time range, the object and the knowledge information about the object related to the user voice and text may be obtained using the context information in a range of time when the user voice and the text are inputted.

FIG. 3 is a block diagram illustrating a configuration of the electronic device of FIG. 2 in detail.

Referring to FIG. 3, the electronic device 100 may include the microphone 110, the memory 120, the processor 130, a communication interface 140, a display 150, a global positioning system (GPS) sensor 160, an another sensor 165, and a speaker 170.

Some configurations of the microphone 110, the memory 120, and the processor 130 are the same as the configurations of FIG. 2 and overlapping description will be omitted.

The communication interface 140 may communicate with the external electronic device. The communication interface 140 is configured to perform communication with the external device. Communicating the communication interface 140 with an external device may include communication via a third device (for example, a repeater, a hub, an access point, a server, a gateway, or the like). Wireless communication may include cellular communication using any one or any combination of the following, for example, long-term evolution (LTE), LTE advanced (LTE-A), a code division multiple access (CDMA), a wideband CDMA (WCDMA), and a universal mobile telecommunications system (UMTS), a wireless broadband (WiBro), or a global system for mobile communications (GSM), and the like. According to an embodiment, the wireless communication may include, for example, any one or any combination of wireless fidelity (Wi-Fi), Bluetooth, Bluetooth low energy (BLE), Zigbee, near field communication (NFC), magnetic secure transmission, radio frequency (RF), or body area network (BAN). Wired communication may include, for example, a universal serial bus (USB), a high definition multimedia interface (HDMI), a recommended standard 232 (RS-232), a power line communication, or a plain old telephone service (POTS). The network over which the wireless or wired communication is performed may include any one or any combination of a telecommunications network, for example, a computer network (for example, local area network (LAN) or wide area network (WAN)), the Internet, or a telephone network.

The communication interface 140 may communicate with an external server to provide an AI agent service. The communication interface 140 may transmit a user query including a changed text to an external server, and may obtain a response to the user query.

The processor 130 may obtain context information at the time when the user voice is input using the information received from the external server. For example, the processor 130 may obtain weather information at a time when a user voice is input from an external server as context information, and may obtain preference information of a user for the object as knowledge information based on the extracted keyword and the obtained weather information. For example, when a user inputs a user voice “I want to drink beer on a day like today” on rainy day, the processor 130 may obtain weather information of today received from an external server as context information, and obtain an object as “rainy day” based on the keyword “day like today” day and weather information. The processor 130 may obtain information that “beer” is “preferred” on a rainy day, and may obtain the information as knowledge information for the “rainy day.”

The processor 130 may transmit updated knowledge database to the external server via the communication interface 140. The processor 130 may receive knowledge database of another user from an external server through the communication interface 140. When a predetermined condition is satisfied, the processor 130 may transmit or receive a knowledge database with an external server. For example, when connected to a network such as a Wi-Fi, or at a predetermined period, the processor 130 may transmit or receive a knowledge database with an external server. As described above, only when a predetermined condition is satisfied, an accurate response may be provided to a user by securing a wider database resources while reducing resources by transceiving with an external server.

According to an embodiment, whether to synchronize the knowledge database with the external server may be performed only when the user accepts synchronization.

The display 150 may display various information according to the control of the processor 130. The display 150 may display a message to identify whether an object associated with the user voice or text input by the user is an object intended by the user. For example, if the user voice “I want to drink beer on a day like today” is inputted, the processor 130 may identify that “day like today” is the “rainy day” by using the trained AI model, and may identify the user's intention displaying, on the display 150, the message “does the day like today mean rainy day?”.

The display 150 may display a response to the user query. The display 150 may be implemented with a touch screen along with a touch panel. The processor 130 may obtain the object and the information about the object based on the text input through the touch panel of the display 150.

The GPS sensor 160 is a sensor capable of sensing location information. The processor 130 may obtain the location coordinates of the electronic device 100 through the GPS sensor 160. The processor 130 may obtain location information sensed through the GPS sensor 160 as context information when a user voice is input. The processor 130 may obtain an object related to a place where a user voice is inputted based on the extracted keyword and the obtained location information. The processor 130 may further use web information to obtain an object related to a place in which a user voice is inputted. For example, if the user inputs “this noodle shop is quiet” at the Gangnam branch of noodle shop AA, the processor 130 may obtain a “Gangnam branch of noodle shop AA” as the object related to the place where the user voice is input by using the keyword “this noodle shop” and the location information obtained by the GPS sensor 160 at the time when the user voice is input. The processor 130 may obtain information indicating that the “mood” is “quiet” as knowledge information about the “Gangnam branch of noodle shop AA”.

The processor 130 may further use web information to obtain an object associated with the user voice. For example, the processor 130 may obtain that the user voice is related to “noodle shop AA” through the extracted keyword and location information, and the chain store of “noodle shop AA” located at the location information obtained through the web information is “Gangnam branch” and may obtain the object related to the place where the user voice is inputted, as “Gangnam branch of noodle shop AA”.

The processor 130 may obtain pre-stored schedule information as context information. The pre-stored schedule information may be stored in the electronic device 100 or received from an external server. The processor 130 may obtain an object related to the user voice based on the keyword and schedule information extracted from the inputted user voice. The object related to the user voice may be an object related to a place where the user voice is inputted. For example, if “launch with friend B” is included in the schedule information of any Saturday, when the user inputs a voice “here is somewhat noise” at the Gangnam branch of noodle shop AA, the processor 130 may extract “here” and “noisy” as keywords from the input user voice. The processor 130 may obtain “weekend”, “lunch” and “restaurant” as the context information based on pre-stored schedule information. The processor 130 may obtain at least one of the location information and the web information sensed by the GPS sensor 160 as context information.

The processor 130 may obtain “Gangnam branch of a noodle shop AA” as the object related to the place where the user voice is input based on the keyword “here” and the obtained context information. As knowledge information about “Gangnam branch of a noodle shop AA” which is the object, the information that “mood” is “noisy” during “weekend” may be obtained as knowledge information.

The processor 130 may identify whether an entity related to the obtained object exists in the knowledge database, and may update the knowledge database by adding the obtained knowledge information to the corresponding entity if the related entity exists. If the related entity does not exist, the knowledge database may be updated by generating a new entity based on the obtained object and knowledge information on the object.

The other sensor 165 may sense various status information of the electronic device 100. For example, the other sensor 165 may include a motion sensor (e.g., a gyro sensor, an acceleration sensor, or the like) capable of sensing motion information of the electronic device 100, and may include a sensor for sensing location information (for example, a global positioning system (GPS) sensor), a sensor (for example, a temperature sensor, a humidity sensor, an air pressure sensor, and the like) capable of sensing environmental information around the electronic device 100, a sensor that can sense user information of the electronic device 100 (e.g., blood pressure sensors, blood glucose sensors, pulse rate sensors, etc.), and the like. The processor 130 may obtain the sensing information sensed by the other sensor 165 as the context information as well.

The speaker 170 is configured to output various notification sounds and a voice message as well as various audio data for which various processing jobs such as decoding, amplification, noise filtering, or the like, are performed. The speaker 170 may output the response to the user query as a voice message in a natural language format. The configuration to output audio may be implemented as a speaker, but this is merely exemplary, and may be implemented as an output terminal that may output audio data.

As described above, because the user uses the context information at the time when the user voice is received, the user's intention may be accurately grasped, and update of the entity pre-stored in the knowledge database may be performed, even though the user utters by using an abstract word, a more accurate response may be provided than a case when a user query is inputted later.

Though not illustrated in FIG. 3, the electronic device 100 may further include various external input ports for connection with an external terminal, a button for receiving a user manipulation, or the like.

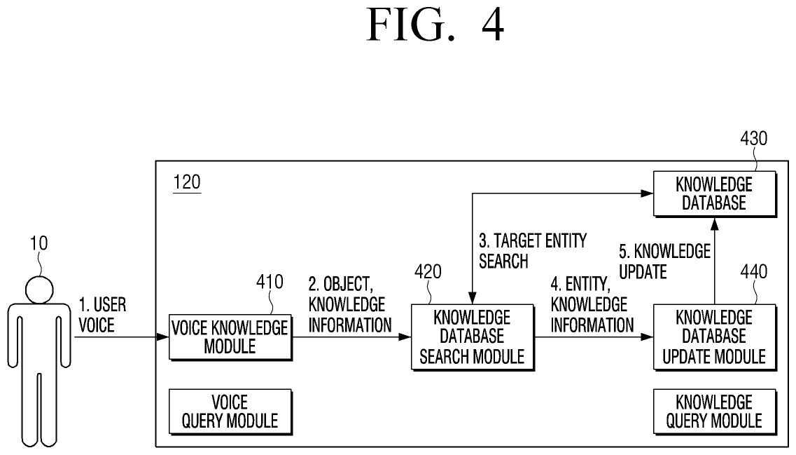

FIG. 4 is a diagram illustrating an operation of updating knowledge database of an electronic device according to an embodiment.

Referring to FIG. 4, various modules may be stored in the memory 120 of the electronic device. The processor of the electronic device may operate using various modules stored in the memory 120.

When the user 10 inputs a user voice, a voice knowledge module 410 may obtain the object and the knowledge information about the object from the inputted user voice. The voice knowledge module 410 may obtain the object and the knowledge information about the object from the user voice by using context information at the time point when the user voice is input. The voice knowledge module 410 may obtain object and knowledge information by utilizing various machine learning technologies such as random forest, logistic regression, etc.

A knowledge database search module 420 may search the target entity in the knowledge database 430 based on the object and knowledge information of the object obtained by the voice knowledge module 410. The knowledge database search module 420 may search for whether an entity related to the obtained object is present in the knowledge database 430. The knowledge database search module 420 may search for whether an entity related to the obtained object exists using a machine learning technique such as a probabilistic logistics regression, and deep learning technique such as a long short-term memory (LSTM), and the like. The knowledge database search module 420 may output the search result and the knowledge information about the object to the knowledge database update module 440.

The knowledge database update module 440 may update the knowledge database 430 based on the entity and knowledge information obtained from the knowledge database search module 420. If an entity associated with the object exists, the knowledge database update module 440 may add knowledge information for the object to the entity to update the knowledge database 430, and the knowledge database update module 440 may generate a new entity corresponding to the object to update the knowledge database 430 if the entity associated with the object does not exist.

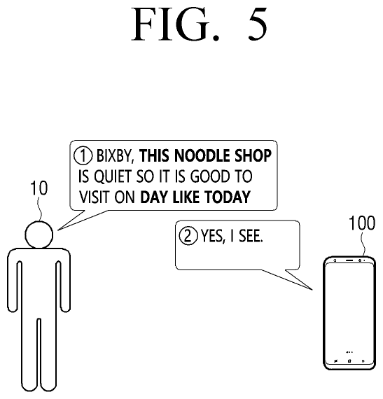

FIG. 5 is a diagram illustrating an operation of receiving a user voice by an electronic device according to an embodiment.

Referring to FIG. 5, the user 10 may input a user voice to the electronic device 100. The user 10 may input a user voice by pressing a button to execute an AI agent or input a user voice including a triggering word (e.g., Bixby).

For example, if the user 10 inputs “Bixby, this noodle shop is quiet so it is good to visit on a day like today”, the electronic device 100 may output the “Yes, I see” as a feedback voice informing that the user voice input has been completed normally. At this time, the feedback voice may not be output according to an embodiment.

As illustrated in FIG. 6, the electronic device may extract the “this noodle shop” 62 and “day like today” 63, which are keywords, from the inputted user voice 61. The electronic device may obtain knowledge information for the object and the object by using the extracted keyword and context information at the time when the user voice is inputted.

For example, the electronic device may obtain the location information sensed by the GPS sensor at the time when the user voice is input as the context information 1 64. The electronic device may obtain the object related to the user voice as “Gangnam branch of noodle shop AA” based on the “this noodle shop” 62 and the context information 1 64. The electronic device may further use web information to obtain an object related to a location where a user voice is inputted.

The electronic device may obtain time information and weather information of the time when the user voice is input as context information 2 66. The electronic device may obtain that the knowledge information for the object is “weekend, rainy day” 67 based on the keyword “day like today” 63 and context information 2 66.

It has been described that the context information 1 64 and context information 2 66 of FIG. 6 include different information, but the information may be the same in part.

Although not illustrated in FIG. 6, the electronic device may further extract “good” as a keyword from the input user voice, and may obtain this as knowledge information about the object “Gangnam branch of noodle shop AA”.

The electronic device may obtain the knowledge information about the object by further using the AI model as illustrated in FIG. 7.

Referring to FIG. 7, the electronic device may input the keyword “day like today” 71 to the AI model 121 and obtain “weekend, rainy day” 73 which is the knowledge information for the object. According to an embodiment, the electronic device may identify whether “day like today” 71 is weekend, rainy day, or weekend and rainy day using the AI model 121.

The electronic device may obtain knowledge information about the object by further inputting the context information 72 along with the keyword 71 to the AI model 121. Referring to FIG. 7, the knowledge information may be obtained using the AI model 121, but in actual implementation, the AI model 121 may be used to obtain the object.

The AI model may be trained based on at least one of the user interaction, search history of a user, sensing information sensed by the electronic device, or user information received from the external device.

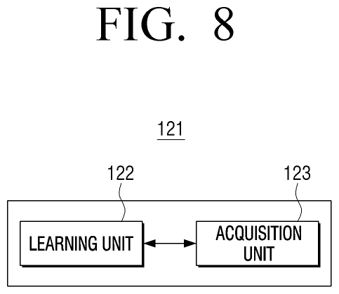

Referring to FIG. 8, the AI model 121 stored in the memory of the electronic device may include a learning unit 122 and an acquisition unit 123. The processor 130 may train learn the learning unit 122 stored in the memory 120 to generate a natural language corresponding to the user intention by executing the learning unit 122 stored in the memory 120. The learning unit 122 according to the disclosure may train a voice recognition model to have the purpose according to the voice recognition. Alternatively, the learning unit 122 according to the disclosure may train a natural language generation model to generate a natural language corresponding to a user intent. The learning unit 122 according to the disclosure may train a model to change or expand text included in a user query into another text. The learning unit 122 may obtain user's propensity information or preference information based on at least one of the interaction of the user, the search history of the user, the sensing information sensed by the electronic device, or the user information received from the external device.

By executing the acquisition unit 123 stored in the memory 120, the processor 130 may control the AI agent to obtain the object or the knowledge information about the object based on the keyword, which is the input data. The acquisition unit 123 may obtain the object or the knowledge information about the object by reflecting the user's tendency information or preference information from the predetermined input data by using the trained AI model. The acquisition unit 123 may provide a response in a natural language form using a natural language generation model. The acquisition unit 123 may change or expand the text of the keyword included in the user query to obtain the object or the knowledge information for the object.

The acquisition unit 123 may identify (or estimate) the predetermined output based on the predetermined input data by obtaining predetermined input data according to a preset criteria and applying the obtained input data to the AI model as an input value. The result value output by applying the obtained input data to the AI model as the input value may be used to update the AI model.

At least some of the learning unit 122 and the acquisition unit 123 may be implemented as a software module or manufactured in the form of at least one hardware chip and mounted on the electronic device. For example, at least one of the learning unit 122 or the acquisition unit 123 may be manufactured in the form of a dedicated hardware chip for AI, or may be manufactured as a part of a conventional general purpose processor (for example: a central processing unit (CPU) or application processor) or graphics only processor (for example: graphics processing unit (GPU)), and mounted on the aforementioned server. A dedicated hardware chip for AI may, for example, be a dedicated processor specialized in probability information. Having a higher parallel processing performance than the general-use processor, the dedicated hardware chip for AI may rapidly process an operation of AI field such as machine learning. When the learning unit 122 and the acquisition unit 123 are implemented as a software module (or a program module including instructions), the software module may be stored in a computer readable non-transitory readable recording medium. In this case, at least one software module may be provided by an operating system (OS) or by a predetermined application. Some of the at least one software module may be provided by an operating system (OS), and others may be provided by a predetermined application.

The learning unit 122 and the acquisition unit 123 may be mounted on one server, or may be mounted on separate servers, respectively. For example, one of the learning unit 122 and the acquisition unit 123 may be included in the first server, and the other one may be included in the second server. In addition, the learning unit 122 and the acquisition unit 123 may provide the model information constructed by the learning unit 122 to the acquisition unit 123 via wired or wireless communication, and provide data that is input to the acquisition unit 123 to the learning unit 122 as additional data.

The AI model may be constructed considering the application field of the recognition model, the purpose of learning, or the computer performance of the device. The AI model may be, for example, a model based on a neural network. The AI model may be designed to simulate the human brain structure on a computer. The AI model may include a plurality of weighted network nodes that simulate a neuron of a human neural network. The plurality of network nodes may each establish a connection relation so that the neurons simulate synaptic activity of transmitting and receiving signals through synapses. For example, the AI model may include a neural network model or a deep learning model developed from a neural network model. In the deep learning model, a plurality of network nodes is located at different depths (or layers) and may exchange data according to a convolution connection. For example, models such as deep neural network (DNN), recurrent neural network (RNN), and bidirectional recurrent deep neural network (BRDNN), long short term memory network (LSTM) may be used as AI models, but are not limited thereto.

FIG. 9 is a diagram illustrating an operation of updating knowledge database according to an embodiment. The knowledge information updated to the knowledge database may be the object related to the obtained user voice and the knowledge information about the object

The electronic device may identify whether an entity associated with the obtained object exists in the knowledge database. As shown in FIG. 9, when an entity “noodle shop AA” related to a “Gangnam branch of noodle shop AA” which is the obtained object is present in the knowledge database, the electronic device may update the knowledge database by adding the obtained object and knowledge information 810 for the object to the entity “noodle shop AA”.

Referring to FIG. 9, it is illustrated that the entity is limited to “noodle shop AA” only, but in actual implementation, the entity related to “weekend” and “quiet” as well as “noodle shop AA” may be searched in the knowledge database and update the knowledge information.

If the entity related to “Gangnam branch of noodle shop AA” which is the obtained object is not present in the knowledge database, the electronic device may generate a new entity corresponding to “Gangnam branch of noodle shop AA” and update the knowledge database.

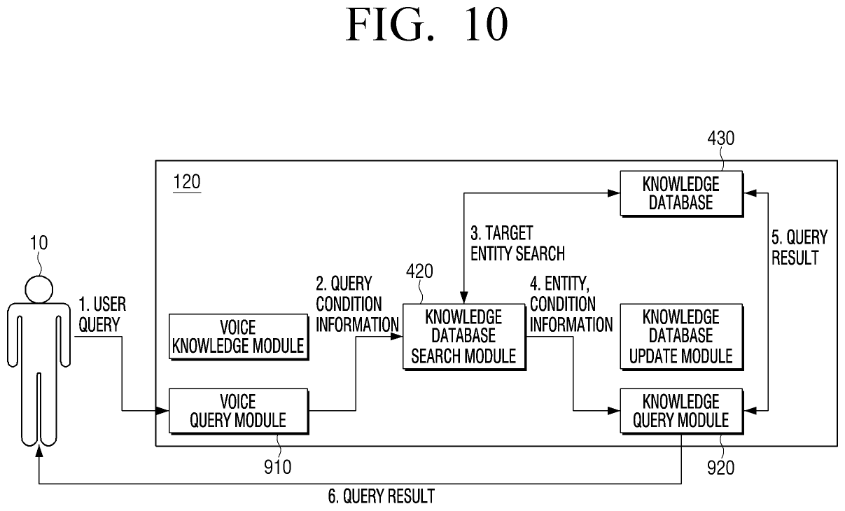

FIG. 10 is a diagram illustrating an operation of outputting a response to a user query by an electronic device according to an embodiment.

Referring to FIG. 10, when the user 10 inputs a user query, the voice query module 910 may obtain a query related to the user intention from the user voice. At this time, the voice query module 910 may obtain a query from the user voice by further using context information at the time when the user query is input. The query may obtain the object related to the user query and the condition information for the object. The voice query module 910 may obtain object and condition information by utilizing various machine learning techniques such as random forest, logistic regression, or the like.

The knowledge database search module 420 may search for the target entity from the knowledge database 430 based on the obtained object from the voice query module 910 and the condition information about the object. The knowledge database 430 may be updated based on the user voice previously inputted and the context information at the time of user voice input.

The knowledge database search module 420 may search whether an entity related to the obtained object exists in the knowledge database 430. The knowledge database search module 420 may search for whether an entity related to the obtained object exists using a machine learning technique such as a probabilistic mathematical regression, a deep learning technique such as LSTM, and the like. The knowledge database search module 420 may output the entity search result and the condition information for the object to the knowledge query module 920.

The knowledge query module 920 may obtain a query result based on the entity and condition information obtained from the knowledge database search module 420. The knowledge query module 920 may update the knowledge database 430 by adding the query related to the user query and the condition information to the information about the obtained entity.

The knowledge query module 920 may provide the user 10 with the obtained query result.

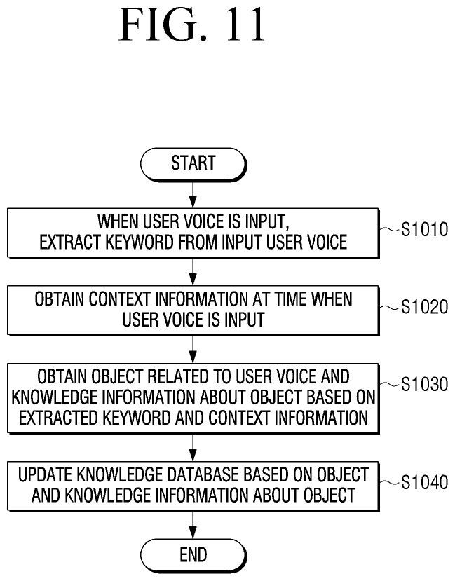

FIG. 11 is a flowchart illustrating an operation of updating knowledge database of the electronic device according to an embodiment.

Referring to FIG. 11, the electronic device may, when a user voice is input, extract a keyword from the input user voice in operation S1010. The electronic device may input the user voice to the voice recognition module and convert the voice to a text, and may extract a noun, a pronoun, an adjective, or the like, as a keyword from the converted text.

In operation S1020, the electronic device may obtain context information at the time when the user voice is input in operation S1020. The context information may include at least one of time information, location information, weather information, and schedule information when the user voice is input. The context information may be obtained from a GPS sensor provided in the electronic device, an external server, pre-stored schedule information, or the like.

The electronic device may obtain the object related to the user voice and knowledge information about the object based on the extracted keyword and context information in operation 51030. For example, based on at least one of location information and pre-stored schedule information, an object related to a location where a user voice is inputted may be obtained. In another embodiment, the electronic device may obtain user preference information of the object as knowledge information based on weather information. According to an embodiment, the electronic device may obtain at least one of the object and the knowledge information about the object by using an AI model.

The electronic device may update knowledge database based on the obtained object and the knowledge information about the object in operation 51040. The electronic device may identify whether an entity relating to the obtained object is present in the knowledge database, and based on the entity relating to the object being present, the electronic device may update the knowledge database by adding, to the entity, the knowledge information relating to the object. Based on the entity relating to the object not being present, the electronic device may generate a new entity corresponding to the object and update the knowledge database.

Though not illustrated in FIG. 11, when a user query is input afterwards, the electronic device may obtain a response to a user query using updated knowledge database and may output the obtained response.

According to various embodiments as described above, by using context information at the time when a user voice is received, even if a user utters by using an abstract term, it is possible to accurately grasp the intention of a user and perform an update for an entity pre-stored in the knowledge database, thereby providing a more accurate response when a user query is inputted later.

The term “unit” or “module” used in the disclosure includes units consisting of hardware, software, or firmware, and is used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

Embodiments may be implemented as software that includes instructions stored in machine-readable storage media readable by a machine (e.g., a computer). A device may call instructions from a storage medium and that is operable in accordance with the called instructions, including an electronic device (e.g., the electronic device 100). When the instruction is executed by a processor, the processor may perform the function corresponding to the instruction, either directly or under the control of the processor, using other components. The instructions may include a code generated or executed by the compiler or interpreter. The machine-readable storage medium may be provided in the form of a non-transitory storage medium. Here, “non-transitory” means that the storage medium does not include a signal and is tangible, but does not distinguish whether data is permanently or temporarily stored in a storage medium.

According to one or more embodiments, a method disclosed herein may be provided in a computer program product. A computer program product may be traded between a seller and a purchaser as a commodity. A computer program product may be distributed in the form of a machine-readable storage medium (e.g., CD-ROM) or distributed online through an application store (e.g., PLAYSTORE™). In the case of online distribution, at least a portion of the computer program product may be stored temporarily or at least temporarily in a storage medium such as a manufacturer's server, a server in an application store, or a memory in a relay server.

Each of the components (for example, a module or a program) according to one or more embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration.

What is claimed is:

1. An electronic device comprising:
a microphone;
a memory configured to include at least one command; and
a processor connected to the microphone and the memory, and configured to control the electronic device,
wherein the processor, by executing the at least one command, is further configured to:
based on a user voice being input through the microphone, extract a keyword from the input user voice,
obtain context information at a point in time when the user voice is input,
obtain an object related to the user voice and knowledge information relating to the object, based on the extracted keyword and the context information, and
update a knowledge database stored in the memory based on the object and the knowledge information relating to the object.

2. The electronic device of claim 1, wherein the knowledge database is configured to store a relationship among knowledge information in an ontology format.

3. The electronic device of claim 2, wherein the processor is further configured to:
identify whether an entity relating to the obtained object is present in the knowledge database; and
based on the entity relating to the object being present, update the knowledge database by adding, to the entity, the knowledge information relating to the object.

4. The electronic device of claim 2, wherein the processor is further configured to, based on an entity relating to the object not being present, generate a new entity corresponding to the object and update the knowledge database.

5. The electronic device of claim 1,
wherein the memory further comprises an artificial intelligence (AI) model trained based on at least one of a user interaction input to the electronic device, a user's search history, sensing information sensed by the electronic device, or user information received from an external device, and
wherein the processor is further configured to obtain the object related to the user voice and the knowledge information relating to the object by inputting the extracted keyword to the AI model.

6. The electronic device of claim 1, wherein the processor is further configured to, based on a user query being input, obtain a response to the user query using the updated knowledge database, and output the obtained response.

7. The electronic device of claim 1, further comprising:
a communication interface,
wherein the processor is further configured to transmit the updated knowledge database to an external server through the communication interface and receive knowledge database of another user from the external server.

8. The electronic device of claim 1, wherein the processor is further configured to obtain at least one of time information, location information, weather information, or schedule information of a point in time when the user voice is input as the context information.

9. The electronic device of claim 8, further comprising:
a global positioning system (GPS) sensor,
wherein the processor is further configured to:
obtain location information sensed by the GPS sensor at the point in time when the user voice is input as the context information, and
obtain an object related to a place where the user voice is input based on at least one of the extracted keyword, the obtained location information, or prestored schedule information.

10. The electronic device of claim 8, further comprising:
a communication interface,
wherein the processor is further configured to:
obtain, from an external server, weather information of a point in time when the user voice is input through the communication interface as the context information, and
obtain preference information of a user relating to the object as the knowledge information based on the extracted keyword and the obtained weather information.

11. A method of controlling of an electronic device, the method comprising:
based on a user voice being input, extracting a keyword from the input user voice;
obtaining context information at a point in time when the user voice is input;
obtaining an object related to the user voice and knowledge information relating to the object, based on the extracted keyword and the context information; and
updating a prestored knowledge database based on the object and the knowledge information relating to the object.

12. The method of claim 11, wherein the knowledge database is configured to store a relationship among knowledge information in an ontology format.

13. The method of claim 12, wherein the updating comprises:
identifying whether an entity relating to the obtained object is present in the knowledge database; and
based on the entity relating to the object being present, updating the knowledge database by adding, to the entity, the knowledge information relating to the object.

14. The method of claim 12, wherein the updating comprises, based on the entity relating to the object not being present, generating a new entity corresponding to the object and updating the knowledge database.

15. The method of claim 11, further comprising:
training a prestored artificial intelligence (AI) model based on at least one of a user interaction input to the electronic device, a user's search history, sensing information sensed by the electronic device, or user information received from an external device,
wherein the obtaining the object and knowledge information relating to the object comprises obtaining the object related to the user voice and the knowledge information relating to the object by inputting the extracted keyword to the AI model.
